(19) United States
(12) Patent Application Publication
(10) Pub. No.: US 2026/0211627 A1
(43) Pub. Date: Jul. 23, 2026

(54) INTERACTION BETWEEN DEVELOPER AND MACHINE BY REDUCING CYCLE TIME EMPLOYING USER STORY EFFECT SCORE TO AUTOMATE API DEVELOPMENT

(71) Applicant: Dell Products L.P., Round Rock, TX (US)

(72) Inventors: Furkan Mohd Nisar, Ambedkar Nagar (IN); Mahender Allam, Ghanpur (IN); Vivek Bhargava, Bangalore (IN); Dinesh Koppada, Bengaluru (IN)

(73) Assignee: Dell Products L.P., Round Rock, TX (US)

(21) Appl. No.: 19/034,773

(22) Filed: Jan. 23, 2025

(51) Int. Cl. G06F 8/30; G06F 40/284; G06F 40/295

(52) U.S. Cl. CPC G06F 8/30; G06F 40/284; G06F 40/295

(57) ABSTRACT

Methods, system, and non-transitory processor-readable storage medium for a user story evaluation system are provided herein. An example method includes receiving, by a user story evaluation system, a user story describing requirements for API development, extracting a plurality of components from the user story, calculating an API development quality score, assigning predefined weights to each evaluated component, generating API development quality score representing an overall measure of the user story's completeness and technical adequacy for API development, and comparing the calculated API development quality score against a predetermined threshold score. When the API development quality score is below the threshold score, identifying missing or incomplete components, generating specific feedback, and providing suggestions for modifying the user story to meet requirements associated with the predetermined threshold score. The user story evaluation system iteratively improves the user story based on the generated feedback.

### FIELD

The field relates generally to evaluating user stories, and in particular evaluating user stories for the purpose of automating API development of the user stories, within information processing systems.

### BACKGROUND

To provide maximum performance, scalability, and maintainability, modern software development requires efficient API implementations.

### SUMMARY

Illustrative embodiments provide techniques for implementing a user story evaluation system in a storage system. For example, illustrative embodiments comprise the user story evaluation system receiving a user story describing requirements for an application programming interface (API) development. The user story evaluation system extracts, using natural language processing techniques, a plurality of components from the user story. The user story evaluation system calculates an API development quality score by evaluating each extracted component against predefined quality criteria for API development, assigning predefined weights to each evaluated component based on a determined relative importance to API development, where the predefined weights correspond to specific API development requirements and generates a composite score (i.e., API development quality score) representing an overall measure of the user story's completeness and technical adequacy for API development. The user story evaluation system compares the calculated API development quality score against a predetermined threshold score. When the API development quality score is below the threshold score, the user story evaluation story identifies missing or incomplete components, generates specific feedback for improving the identified components, and provides suggestions for modifying the user story to meet requirements associated with the predetermined threshold score (i.e., “threshold score”). The user story evaluation system iteratively improves the user story based on the generated feedback until the API development quality score meets or exceeds the threshold score. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a user story evaluation system, in an illustrative embodiment.

FIG. 2 shows a flow diagram of a process for a user story evaluation system, in an illustrative embodiment.

FIG. 3 illustrates an example initial user story, in an illustrative embodiment.

FIG. 4 illustrates the components extracted from the initial user story, in an illustrative embodiment.

FIG. 5 illustrates assigning a base importance/significance score to each component, in an illustrative embodiment.

FIG. 6 illustrates each adjusted criterion with its base score and impact multiplier, in an illustrative embodiment.

FIG. 7 illustrates an example user story, in an illustrative embodiment.

FIG. 8 illustrates an example flow diagram of the user story evaluation system, in an illustrative embodiment.

FIGS. 9 and 10 show examples of processing platforms that may be utilized to implement at least a portion of a user story evaluation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Automatic generation of APIs require maintaining code standards, terminology, and customizations consistent across different backend systems. The inability of developers to become proficient in every backend technology often leads to standard deviations in coding. In addition, there are ambiguous, incomplete user stories that do not conform to API norms in the current API development process. The development process is made more difficult by the fact that these user stories are not designed to facilitate automated code generation.

Errors in the API development process arise from vague and inadequate user stories, which lead to misunderstandings and incorrect readings. Mistakes or omissions of critical requirements by developers can result in functional inconsistencies and flaws in the finished API product. When poorly written user stories need to be repeatedly clarified and revised, time and resources are wasted. User story review, refinement, and validation involves a considerable amount of manual labor. The quality and effectiveness of API development is further affected by this as it slows down the development process and increases the chance of human error.

Modern user stories are not written in a way that facilitates automated code generation; this is a major obstacle. The development process is made more difficult by the fact that they often lack the organized, comprehensive data needed for AI and other automation tools to produce code directly from a user story.

Described below is a technique for use in implementing a user story evaluation system, which technique may be used to ensure that user stories are complete, well-defined, and customized to make automated code generation for APIs. The user story evaluation system receives a user story describing requirements for an API development. The user story evaluation system extracts, using natural language processing techniques, a plurality of components from the user story. The user story evaluation system calculates an API development quality score by evaluating each extracted component against predefined quality criteria for API development, assigning predefined weights to each evaluated component based on a determined relative importance to API development, where the predefined weights correspond to specific API development requirements and generates a composite score representing an overall measure of the user story's completeness and technical adequacy for API development. The user story evaluation system compares the calculated API development quality score against a predetermined threshold score. When the API development quality score is below the threshold score, the user story evaluation story identifies missing or incomplete components, generates specific feedback for improving the identified components, and provides suggestions for modifying the user story to meet requirements associated with the predetermined threshold score. The user story evaluation system iteratively improves the user story based on the generated feedback until the API development quality score meets or exceeds the threshold score. Other types of processing devices can be used in other embodiments. These and other illustrative embodiments include, without limitation, apparatus, systems, methods and processor-readable storage media.

Conventional technologies fail to automate the process of creating and assessing user stories to optimize the development of APIs. Conventional technologies fail to ensure that user stories are complete, well-defined, and customized to enable automated code generation for APIs. Conventional technologies fail to provide an AI-based system that evaluates user stories by giving them an efficacy score that is determined by standards that are crucial for API development. Conventional technologies fail to provide an AI-powered evaluation system that generates an efficacy score based on AI analysis for user stories and conventional technologies also fail to provide recommendations for user story enhancements. Conventional technologies fail to provide feedback for initial user stories to improve the user stories to clearly outline the requirements for API development such that automatic code generation tools can produce the code for API development. Conventional technologies fail to establish a system of effect scoring to assess each user story's level of quality and readiness of code generation for API development. Conventional technologies fail to provide AI-generated comments and ideas for improving those user stories that fall short of the quality threshold, and fail to iteratively modify user stories until they satisfy the necessary requirements for code generation. Conventional technologies fail to verify that user stories are prepared for automated code creation by ensuring these user stories have the information and elements required to enable precise and comprehensive API development automation.

By contrast, in at least some implementations in accordance with the current technique as described herein, the development of APIs is optimized by providing an AI-based system that evaluates user stories by giving them an efficacy score that is determined by standards that are crucial for API development. A user story evaluation system receives a user story describing requirements for an API development. The user story evaluation system extracts, using natural language processing techniques, a plurality of components from the user story. The user story evaluation system calculates an API development quality score by evaluating each extracted component against predefined quality criteria for API development, assigning predefined weights to each evaluated component based on a determined relative importance to API development, where the predefined weights correspond to specific API development requirements and generates a composite score representing an overall measure of the user story's completeness and technical adequacy for API development. The user story evaluation system compares the calculated API development quality score against a predetermined threshold score. When the API development quality score is below the threshold score, the user story evaluation story identifies missing or incomplete components, generates specific feedback for improving the identified components, and provides suggestions for modifying the user story to meet requirements associated with the predetermined threshold score. The user story evaluation system iteratively improves the user story based on the generated feedback until the API development quality score meets or exceeds the threshold score. Other types of processing devices can be used in other embodiments. These and other illustrative embodiments include, without limitation, apparatus, systems, methods and processor-readable storage media.

Thus, a goal of the current technique is to provide a method and a system for a user story evaluation system that can automate the process of creating and assessing user stories to optimize the development of APIs. Another goal is to ensure that user stories are complete, well-defined, and customized to enable automated code generation for APIs. Another goal is to provide an AI-based system that evaluates user stories by giving them an efficacy score that is determined by standards that are crucial for API development. Another goal is to provide AI-powered evaluation system that generates an efficacy score based on AI analysis for user stories and provides recommendations for user story enhancements. Another goal is to provide feedback for initial user stories to improve the user stories to clearly outline the requirements for API development such that automatic code generation tools can produce the code for API development. Another goal is to establish a system of effect scoring to assess each user story's level of quality and readiness of code generation for API development. Another goal is to provide AI-generated comments and ideas for improving those user stories that fall short of the quality threshold, and iteratively modify user stories until they satisfy the necessary requirements for code generation. Another goal is to verify that user stories that satisfy the threshold are prepared for automated code creation by ensuring these user stories have the information and elements required to enable precise and comprehensive API development automation. Another goal is to break the technical expertise barrier so that any developer can create the API with the required technology stack. Yet another goal is to follow the organization code standards and providing the optimized code for the user.

In at least some implementations in accordance with the current technique described herein, the use of a user story evaluation system can provide one or more of the following advantages: uses pre-established standards such as completeness, clarity, and relevance that are essential for API development, provides a quality threshold that guides developers in improving the user stories to adhere to development standards, provides iterative feedback for continuous improvement, maximizes the quality of user stories and development readiness, enhances productivity as development teams achieve higher productivity by automating procedures related to code generation and user story evaluation, ensures that only excellent user stories move forward to the development phase when a threshold score is set for the effectiveness of the user story, thereby reducing uncertainty and misunderstandings between developers and stakeholders by producing clearer, more complete, and better aligned user stories, results in better collaboration and communication between development teams and stakeholders by the reiterative strategy, which offers actionable feedback on user stories that do not meet the threshold, guaranteeing that everyone is working towards the same objectives and fosters a culture of continual improvement, ensures that user stories are detailed, understandable, and compliant with API development specifications resulting in improved code quality because code is implemented more consistently and reliably when it is generated automatically using standardized user stories, streamlining the development process and reducing human labor, allows companies to launch new APIs more quickly resulting in faster Time-To-Market, allows automation of repetitive operations and the provision of actionable feedback for improvement, enabling quick iteration and deployment, allowing organizations to stay ahead of the competition and adapt immediately to market demands, generates a user story that is considered ready for development and is eligible for automated code generation processes, and creates precise, structured user stories that are optimized for automated code generation by employing natural language processing (NLP) approaches.

In contrast to conventional technologies, in at least some implementations in accordance with the current technique as described herein, the process of creating and assessing user stories is automated to optimize the development of APIs. The user story evaluation system receives a user story describing requirements for an API development. The user story evaluation system extracts, using natural language processing techniques, a plurality of components from the user story. The user story evaluation system calculates an API development quality score by evaluating each extracted component against predefined quality criteria for API development, assigning predefined weights to each evaluated component based on a determined relative importance to API development, where the predefined weights correspond to specific API development requirements and generates a composite score representing an overall measure of the user story's completeness and technical adequacy for API development. The user story evaluation system compares the calculated API development quality score against a predetermined threshold score. When the API development quality score is below the threshold score, the user story evaluation story identifies missing or incomplete components, generates specific feedback for improving the identified components, and provides suggestions for modifying the user story to meet requirements associated with the predetermined threshold score. The user story evaluation system iteratively improves the user story based on the generated feedback until the API development quality score meets or exceeds the threshold score.

In an example embodiment of the current technique, when the API development quality score meets or exceeds the threshold score, the user story evaluation system designates the user story as ready for automated API code generation and promotes the user story to a code generation phase.

In an example embodiment of the current technique, the user story evaluation system verifies all required components meet minimum quality standards, confirms the presence of necessary technical details, and prepares the user story for automated API code generation.

In an example embodiment of the current technique, the components comprise an endpoint URL, an HTTP method, request parameters, a response format, authentication requirements, error handling specifications, data validation rules, a use case description, performance requirements, data retrieval details, security requirements and pagination parameters.

In an example embodiment of the current technique, the endpoint URL component comprises a specific URL for accessing the API and defined path parameters within the URL.

In an example embodiment of the current technique, the request parameters component comprises path parameters defined as variables within the endpoint URL, query parameters added following a question mark in the URL, and body parameters for PUT, PATCH, and POST operations.

In an example embodiment of the current technique, the response format component specifies the format for returned data and a structure for response parsing and handling by clients.

In an example embodiment of the current technique, the authentication requirements component comprises specification of authentication methods, token requirements, and security protocols for API access.

In an example embodiment of the current technique, the error handling component comprises error codes, error messages, and specific handling procedures for different error scenarios.

In an example embodiment of the current technique, the data validation rules component comprises specifications for mandatory fields, data type requirements, and field-specific limitations.

In an example embodiment of the current technique, the data retrieval details component comprises database connection strings, table specifications, view definitions, and data source access parameters.

In an example embodiment of the current technique, the security requirements component comprises encryption requirements, rate limiting specifications, and data protection measures.

In an example embodiment of the current technique, the pagination component comprises page size specifications, offset parameters, and total items tracking.

In an example embodiment of the current technique, the predefined weights comprise 10 points for an endpoint URL, 10 points for an HTTP method, 20 points for request parameters, 10 points for a response format, 15 points for authentication requirements, 10 points for error handling specifications, 15 points for data validation rules, 5 points for use case description, 10 points for performance requirements, 20 points for data retrieval details, 15 points for security requirements, and 10 points for pagination parameters.

In an example embodiment of the current technique, the user story evaluation system performs tokenization to divide the user story text into discrete elements, where the discrete elements comprise words, numbers, and special characters, performs sentence segmentation by identifying sentence boundaries based on punctuation marks and grammatical structures, and analyzes the grammatical structure using dependency parsing to determine relationships between words and identify component-specific dependencies within the user story.

In an example embodiment of the current technique, the user story evaluation system performs named entity recognition to identify and classify specific technical entities within the user story, where the technical entities comprise at least database names, table names, API endpoints, and data fields, performs part-of-speech tagging to label words with corresponding parts of speech to facilitate identification of technical specifications and requirements, and validates identified technical entities against predefined API development patterns and nomenclature standards.

In an example embodiment of the current technique, the user story evaluation system evaluates each component extracted through natural language processing against predefined criteria for completeness and clarity, where the evaluation incorporates identified technical entities and grammatical relationships, multiplies each component's base score by an impact multiplier based on validated technical specifications to generate a weighted score, and sums the weighted scores of all components to generate the API development quality score.

In an example embodiment of the current technique, the user story evaluation system validates the extracted components against predefined patterns using named entity recognition results, checks for consistency in technical specifications based on identified component-specific dependencies, and ensures alignment with API development standards through analysis of classified technical entities.

In an example embodiment of the current technique, the user story evaluation system generates a detailed report of the API development quality score calculation, including component-wise identification of technical entities, provides a component-wise breakdown of scores with associated technical specifications and dependencies, and highlights areas requiring improvement based on the validated technical entities and identified relationships between components.

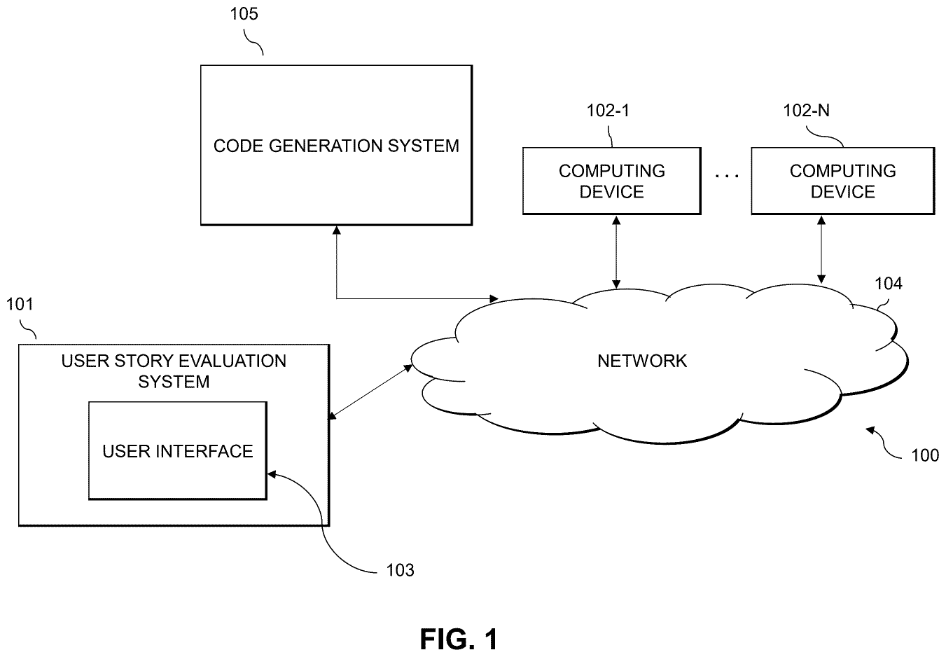

FIG. 1 shows a computer network (also referred to herein as an information processing system) 100 configured in accordance with an illustrative embodiment. The computer network 100 comprises a user story evaluation system 101 comprising a user interface 103, code generation system 105, and computing devices 102-N. The user story evaluation system 101, code generation system 105, and computing devices 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The user story evaluation system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the user story evaluation system 101, code generation system 105, and computing device 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user story evaluation system 101, code generation system 105, and computing device 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the user story evaluation system 101 are one or more input-output devices, which illustratively comprise keyboards, displays or other types of input-output devices in any combination. Such input-output devices can be used, for example, to support one or more user interfaces to the user story evaluation system 101, code generation system 105, as well as to support communication between the user story evaluation system 101 and other related systems and devices not explicitly shown. For example, a dashboard may be provided for a user to view results produced by the user story evaluation system 101. One or more input-output devices may also be associated with any of the user story evaluation system 101, code generation system 105, and computing device 102-N.

Additionally, the user story evaluation system 101 in the FIG. 1 embodiment is assumed to be implemented using at least one processing device. Each such processing device generally comprises at least one processor and an associated memory, and implements one or more functional modules for controlling certain features of the user story evaluation system 101.

More particularly, the user story evaluation system 101 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the user story evaluation system 101 to communicate over the network 104 with the user story evaluation system 101, code generation system 105, and computing device 102-N and illustratively comprises one or more conventional transceivers.

A user story evaluation system 101 may be implemented at least in part in the form of software that is stored in memory and executed by a processor, and may reside in any processing device. The user story evaluation system 101 may be a standalone plugin that may be included within a processing device.

It is to be understood that the particular set of elements shown in FIG. 1 for user story evaluation system 101 involving the user story evaluation system 101, code generation system 105, and computing device 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the user story evaluation system 101 can be on and/or part of the same processing platform.

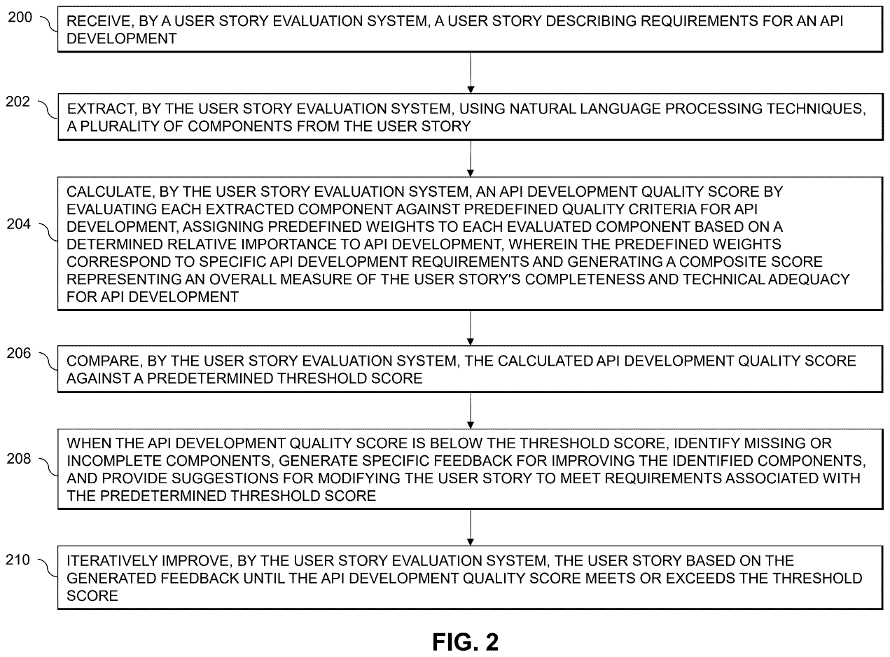

An exemplary process of user story evaluation system 101 in computer network 100 will be described in more detail with reference to, for example, the flow diagram of FIG. 2.

FIG. 2 is a flow diagram of a process for execution of the user story evaluation system 101 in an illustrative embodiment. It is to be understood that this particular process is only an example, and additional or alternative processes can be carried out in other embodiments.

At 200, the user story evaluation system 101 receives a user story describing requirements for an application programming interface (API) development. In an example embodiment, an example initial user story may read as follows, “As a user, I want to create a new account. I just need to enter my username, email address and password to create an account. I want to be sure that my data is secure and that I can log in quickly and easily at all times. I should be informed in case of any error. The platform should be able to accommodate a lot of users simultaneously without any delays”. In an example embodiment, the user may enter the user story in the user interface 103. Alternatively, the user may enter the user story in a computing device 102-N, where the user story evaluation system 101 receives the user story from the computing device 102-N through the network 104.

At 202, the user story evaluation system 101 extracts a plurality of components from the user story using natural language processing techniques. In an example embodiment, the user story evaluation system 101 defines baseline requirements for user stories to guarantee that the API developers are provided with thorough and understandable guidance to allow the developers to write the API code efficiently. In an example embodiment, the minimum components comprise an endpoint uniform resource locator (URL), a Hypertext Transfer Protocol (HTTP) method, request parameters, a response format, authentication requirements, error handling specifications, data validation rules, a use case description, performance requirements, data retrieval details, security requirements and pagination parameters.

In an example embodiment, the endpoint URL component comprises a specific URL for accessing the API and defined path parameters within the URL, for example /api/v1/users. In other words, the specific URL that allows user to access the API. By clearly specifying the endpoint URL, the developers are aware of the precise location of the API's implementation to provide proper routing and API access.

In an example embodiment, the HTTP method (for example, GET, POST, PUT, DELETE) defines the action to be performed. The HTTP method defines the type of request to be sent together with the action that is required to be taken on the server (such as obtaining information, generating a resource, editing a resource, or removing a resource. There are particular handling and semantic criteria for each method.

In an example embodiment, the request parameters component comprises path parameters defined as variables within the endpoint URL, query parameters added following a question mark in the URL, and body parameters for PUT, PATCH, and POST operations. The path parameters define variables that are part of the endpoint URL, for example, if the endpoint URL is: /api/v1/users/{userId}, then “/{userId}” is the path parameter. The query parameters are added to the endpoint URL following a question mark. For example, if the endpoint URL is /api/v1/users?active=true, then “active=true” is a query parameter. The body parameters comprise information that is sent in the request body, usually for PUT, PATCH, and POST operations, for example, “username”: “john_doe”, “email”: john@example.com. The request parameters ensure that the API can process incoming requests and data accurately by clearly defining these criteria, outlining the kind and structure of data that the API expects.

In an example embodiment, the response format component specifies the format for returned data and a structure for response parsing and handling by clients. The response format (such as JSON or XML) specifies the format in which the data is returned by the API, assuring consistency in the data that the API returns and facilitates accurate response parsing and handling by clients. An example response format is as follows: “id”: “123”, “username”: “john_doe”, “email”: john@example.com.

In an example embodiment, the authentication requirements component comprises specification of authentication methods, token requirements, and security protocols for API access. The authentication requirements provides information on the user authentication process (i.e., OAuth token, API keys, etc.) for accessing the API. The authentication requirements establish the security protocols to safeguard the API, guaranteeing that the API is restricted to authorized users only. An example authentication requirement is as follows: “The authorization header must contain a bearer token”.

In an example embodiment, the error handling component comprises error codes, error messages, and specific handling procedures for different error scenarios. The error handling component is the method that is used to report and manage errors (such as error codes and messages). The error handling component guarantees that the API provides informative feedback to clients and users in the event of an error or failure. This makes error management and troubleshooting simpler. An example error handling component is as follows: “400 An incorrect input request resulted in a 404 Not Found error for non-existent resources”.

In an example embodiment, the data validation rules component comprises specifications for verifying input data rules for mandatory fields, data type requirements, and field-specific limitations. The data validation rules component prevents the processing of erroneous or malicious data by verifying that the data received by the API is legitimate and satisfies the necessary requirements. An example data validation rule is as follows: “The password must have a minimum of eight characters and the username must not be an empty string”.

In an example embodiment, the data retrieval details component comprises details on the database connection strings, table specifications, view definitions, and data source access parameters that are used to retrieve/store/edit the data to and from a database or other sources. The data retrieval details ensure that the API can accurately retrieve/store/edit/update and handle the necessary data by giving comprehensive guidance on how to connect and communicate with the data sources.

In an example embodiment, the security requirements component comprises encryption requirements, rate limiting specifications, and data protection measures. The security requirements specify security precautions (such as rate limitation and encryption) to safeguard the API. The security requirements establish the essential security procedures to defend the API against intrusions and guarantees the confidentiality and integrity of the data. An example security requirement is as follows: “to prevent abuse, every data in transit needs to be encrypted using TLS”.

In an example embodiment, the pagination component comprises page size specifications, offset parameters, and total items tracking. The pagination component provides information on how to handle large datasets by breaking them up into manageable pages, together with specification for page number and size. The pagination component guarantees that big datasets may be managed and returned by the API in an effective manner, enhancing efficiency and usability by only delivering a portion of the data at once. An example pagination component is as follows:
Query Parameters: page, pageSize
Implementation: GET /api/v1/users?page=1&pageSize=20
Output:
{
   “data”: [
      {“id”: “1”, “username”: “john_doe”},
      . . .
   ],
   “pagination”: {
      “currentPage”: 1,
      “pageSize”: 20,
      “totalPages”: 10,
      “totalItems”: 200
   }
}

In an example embodiment, the user story evaluation system 101 extracts the components using natural language processing techniques to create precise, structured user stories that are optimized for automated code generation. The user story evaluation system 101 integrates natural language processing (NLP) techniques into the narrative crafting process. After analyzing the input (i.e., the initial user story), the user story evaluation system 101 creates user stories that are logical, brief and have precise parameters and requirements. In an example embodiment, the user story evaluation system 101 parses the initial user story to extract and identify each component necessary for API development. The user story evaluation system 101 uses natural language processing and pattern matching techniques. The extracted components are then evaluated against predefined criteria to calculate an effect score (i.e., API development quality score).

In an example embodiment, the user story evaluation system 101 performs tokenization to divide the user story text into discrete elements, where the discrete elements comprise words, numbers, and special characters. The user story evaluation system 101 divides text into discrete elements, such as words or tokens. The initial user story is divided into digestible chunks by using tokenization (i.e., words and punctuation). An example tokenization is as follows:
doc=nlp(user_story_text)
tokens=[token.text for token in doc]

An example initial user story: As a user, I want to create a new account so that I can access the platform's features.

Tokenization: [‘As’, ‘a’, ‘user’, ‘,’, ‘I’, ‘want’, ‘to’, ‘create’, ‘a’, ‘new’, ‘account’, ‘so’, ‘that’, ‘I’, ‘can’, ‘access’, ‘the’, ‘platform’, “'s”, ‘features’, ‘.’]

In an example embodiment, the user story evaluation system 101 performs sentence segmentation by identifying sentence boundaries based on punctuation marks and grammatical structures. The user story evaluation system 101 identifies the boundaries of sentences within a text to analyze each statement independently. An example of sentence segmentation is as follows:
sentences =[sent. text for sent in doc.sents]

An example initial user story: “As a user, I want to create a new account so that I can access the platform's features. POST /api/v1/users”.

Sentences segmentation is: [‘As a user, I want to create a new account so that I can access the platform's features.’, ‘POST /api/v1/users’].

In an example embodiment, the user story evaluation system 101 analyzes the grammatical structure using dependency parsing to determine relationships between words and identify component-specific dependencies within the user story. The user story evaluation system 101 analyzes the grammatical structure of a sentence and establishes relationships between “head” words and words that modify those heads. The dependency parsing facilitates comprehension of sentence syntactic structure, which is essential for determining the connections between various elements, such as parameters and their values. An example of dependency parsing illustrating that username, email, and password are all parameters related to the request is as follows:
for token in doc:
   print(f“{token.text} ({token.dep_})-->{token.head.text}”)
Request parameters: username, email, password
Output:
Request (nsubj)-->parameters
parameters (ROOT)-->parameters
username (appos)-->parameters
, (punct)-->username
email (conj)-->username
, (punct)-->email
password (conj)-->username

In an example embodiment, the user story evaluation system 101 performs named entity recognition (NER) to identify and classify specific technical entities within the user story. In an example embodiment, the technical entities comprise at least database names, table names, API endpoints, and data fields. NER facilitates identifying entities such as database names, table names, API endpoints, and specific data fields. An example named entity recognition is as follows:
import spacy
nlp=spacy.load(“en_core_web_sm”)
doc=nlp(“Data retrieval: Server=myServerAddress;Database=myDataBase;User Id=myUsername; Password=myPassword; Table: Users”)
entities=[(ent.text, ent.label_) for ent in doc.ents]
print(entities)
Output:
[(‘Server=myServerAddress’, ‘ORG’), (‘Database=myDataBase’, ‘ORG’), (‘User Id=myUsername’, ‘PERSON’), (‘Password=myPassword’, ‘PERSON’), (‘Table: Users’, ‘ORG’)]

In an example embodiment, the user story evaluation system 101 performs part-of-speech tagging to label words with corresponding parts of speech to facilitate identification of technical specifications and requirements. The user story evaluation system 101 labels each word in a sentence with its corresponding part of speech (i.e., noun, verb, adjective, etc.). By understanding the function of each word in a phrase, the user story evaluation system 101 can recognize important parts like verbs (verbs of action) and nouns. An example part-of-speech tagging is as follows:
for token in doc:
   print(f“{token.text} ({token.pos_})”)
Story Sentence: POST /api/v1/users
Output:
POST (VERB)
/api/v1/users (NOUN)

The above example indicates an endpoint since /api/v1/users is a noun phrase and POST is an action. In an example embodiment, the spaCy model is used to parse, analyze and extract user story components efficiently. In an example embodiment, the user story evaluation system 101 validates identified technical entities against predefined API development patterns and nomenclature standards.

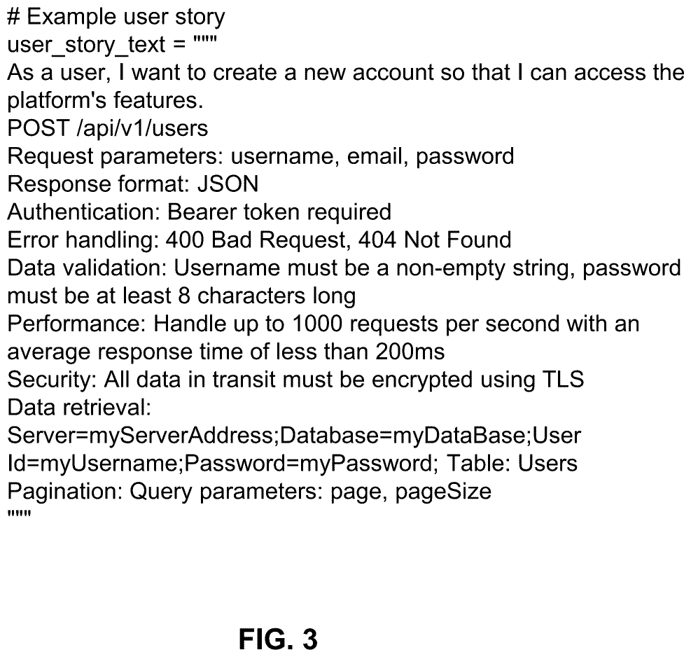

FIG. 3 illustrates an example initial user story. The user story evaluation system 101 receives the initial user story as input and calls the extract_components function that processes the initial user story and extracts the required components. For example:
components=extract_components(user_story_text)
print(components)

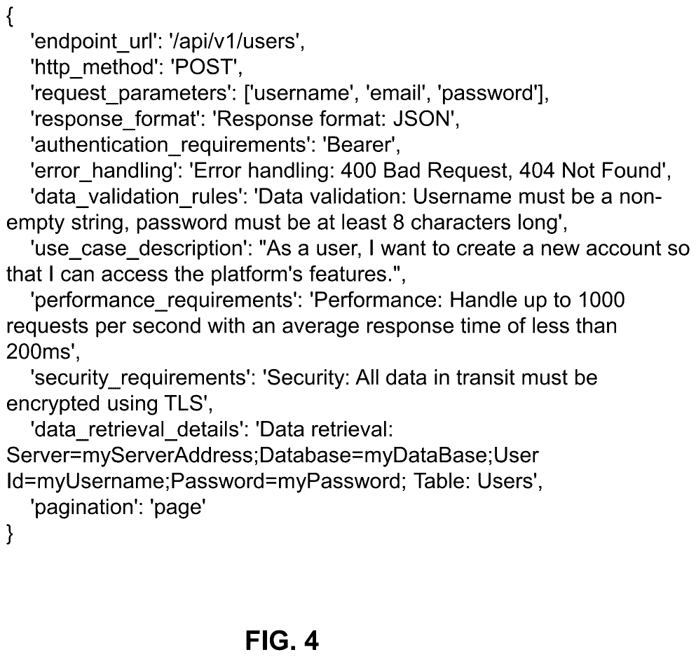

The output of the extract_components function is a dictionary containing the extracted components. FIG. 4 illustrates the extracted components. The endpoint URL (endpoint_url) is extracted using a regular expression to find URL patterns. The HTTP Method (http_method) is identified by searching for common HTTP method keywords. The request parameters (request_parameters) are extracted by identifying terms related to parameters and capturing their dependencies. The response format (response_format) is identified by searching for keywords related to response format in the text. The authentication requirements (authentication_requirements) are extracted by searching for terms related to authentication methods. The error handling (error_handling) is extracted by identifying sentences containing keywords related to error handling. The data validation rules (data_validation_rules) are identified by searching for sentences containing terms related to data validation. The use case description (use_case_description) is extracted by identifying sentences starting with common user story phrases such as “As a user”. The performance requirements (performance_requirements) are identified by searching for terms related to performance requirements. The security requirements (security_requirements) are extracted by searching for sentences containing terms related to security. The data retrieval details (data_retrieval_details) are extracted by identifying sentences containing terms related to data retrieval and database connection details. The pagination (pagination) is identified by searching for keywords related to pagination in the text.

At 204, the user story evaluation system 101 calculates an API development quality score by evaluating each extracted component against predefined quality criteria for API development. In an example embodiment, the user story evaluation system 101 assigns predefined weights to each evaluated component based on a determined relative importance to API development, where the predefined weights correspond to specific API development requirements. In an example embodiment, the user story evaluation system 101 evaluates the relative significance of each element in the context of API development to assign the weights to each criterion. In an example embodiment, the user story's more crucial elements are given higher weights. For example, higher weights are assigned to components that are crucial to the API's basic operation, and to elements like clarity and completeness that have a big impact on the development process. In an example embodiment, the user story evaluation system 101 prioritizes components that guarantee the API's security and compliance and prioritizes components that make the development process simpler and less confusing. In an example embodiment, the user story evaluation system 101 properly weights criteria that weight criteria that have an impact on the API's scalability and performance. The maintainability of the user story evaluation system 101 depends on following coding rules and standards and this is reflected in the weights.

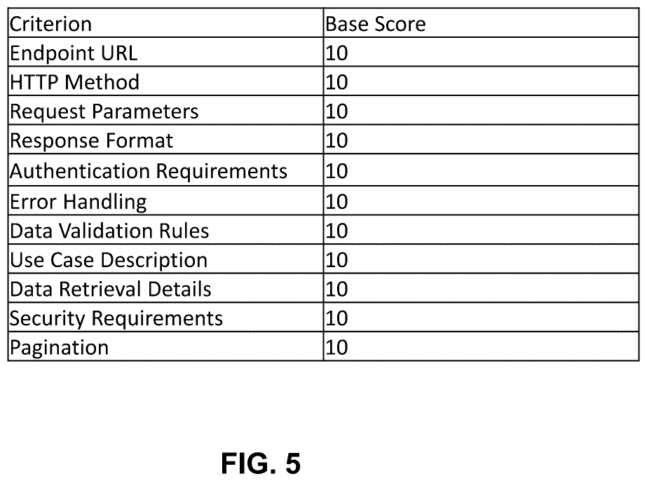

In an example embodiment, the user story evaluation system 101 takes into account several characteristics, including the component's relevance, complexity, and impact on the entire development process to determine the effect/score (i.e., the component score) of each component in a user story. In an example embodiment, the user story evaluation system 101 provides each component with a base significance score, with higher base significance scores are assigned to components that are essential to the basic functioning of the user story. FIG. 5 illustrates assigning a base importance/significance score to each component.

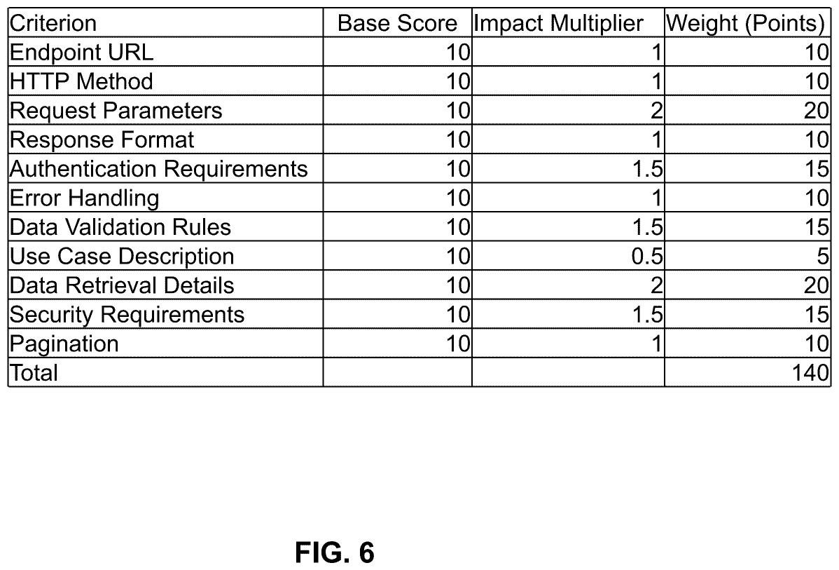

In an example embodiment, the user story evaluation system 101 adjusts the component score based on how the component affects the API's performance, security, quality, maintainability, etc. In an example embodiment, the user story evaluation system 101 modifies each component's base importance score according to their impact and complexity, using multiplier factors. FIG. 6 illustrates each adjusted criterion with its base score and impact multiplier. In an example embodiment, the predefined weights comprise 10 points for an endpoint URL, 10 points for an HTTP method, 20 points for request parameters, 10 points for a response format, 15 points for authentication requirements, 10 points for error handling specifications, 15 points for data validation rules, 5 points for use case description, 10 points for performance requirements, 20 points for data retrieval details, 15 points for security requirements, and 10 points for pagination parameters. The endpoint URL receives 10 points; it is critical for routing and accessing the API. The HTTP method receives 10 points; it defines the type of request and its action. The request parameters receive 20 points; they are essential for processing incoming requests and data. The response format receives 10 points; it ensures consistency in the data returned by the API. The authentication requirements receive 15 points; they are crucial for API security. The error handling receives 10 points; it provides meaningful feedback and facilitates debugging. The data validation rules receive 15 points; they ensures data integrity and prevents invalid data processing. The use case description receives 5 points; it ensures information about the use case is included. The data retrieval details receive 20 points; they are essential for accessing and interacting with data sources correctly. The security requirements receive 15 points; they ensure data protection and prevent attacks. The pagination receives 10 points; it is important for handling large datasets efficiently.

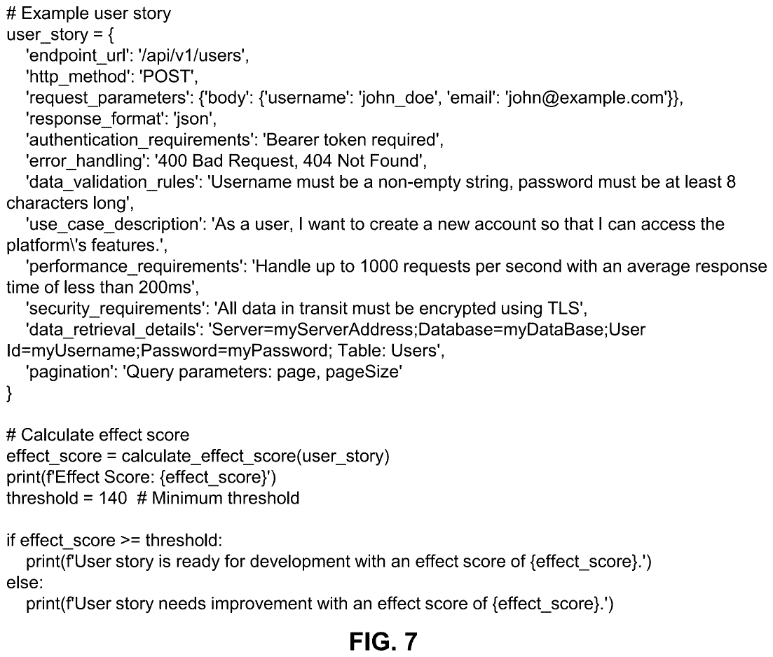

In an example embodiment, the user story evaluation system 101 generates a composite score (i.e., API development quality score) representing an overall measure of the user story's completeness and technical adequacy for API development. FIG. 7 illustrates an example user story. A user story must score 140 points to be considered ready for development, meaning the user story meets the basic criteria required to generate code for an API.

In an example embodiment, as discussed above, the user story evaluation system 101 evaluates each component extracted through natural language processing against predefined criteria for completeness and clarity, where the evaluation incorporates identified technical entities and grammatical relationships. The user story evaluation system 101 multiplies each component's base score by an impact multiplier based on validated technical specifications to generate a weighted score. In an example embodiment, the user story evaluation system 101 sums the weighted scores of all components to generate the API development quality score.

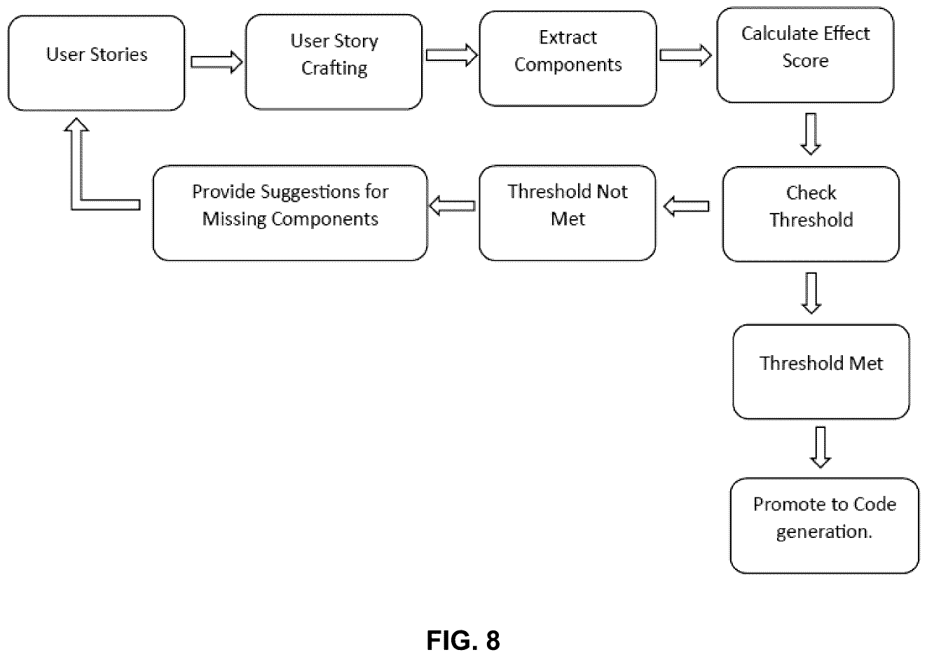

At 206, the user story evaluation system 101 compares the calculated API development quality score against a predetermined threshold score. For example, if the calculated API development score is 110 and the predetermined threshold score is 140, then the user story evaluation system 101 provides feedback on suggested improvements to bring the calculated API development score equal to or above the predetermined threshold. The user story evaluation system 101 comprises an extract_components function that parses the user story and identifies the presence of each required component. The user story evaluation system 101 comprises a generate_effect_score function that calculates the total effect score based on the presence of each component and their respective weights. The user story evaluation system 101 comprises a provide_feedback function that compares the calculated effect score (i.e., API development quality score) against the defined threshold. If the total effect score (i.e., API development quality score) is equal to or above the predetermined threshold, the user story evaluation system 101 outputs, “The user story is ready for development”. If the total effect score is below the predetermined threshold, the user story evaluation system 101 outputs, for example, “The user story is not ready for development. Please add or improve the following components: Error handling and Performance requirements”. FIG. 8 illustrates an example flow diagram of the user story evaluation system 101.

At 208, when the API development quality score is below the threshold score, the user story evaluation system 101 identifies missing or incomplete components. The user story evaluation system 101 generates specific feedback for improving the identified components, and provides suggestions for modifying the user story to meet requirements associated with the predetermined threshold score. In an example embodiment, feedback on missing components is provided if the threshold score is not met. The user story evaluation system 101 verifies that every component satisfies a predetermined list of necessary components (i.e., minimum components) for user stories. In an example embodiment, if any elements are absent, the user story evaluation system 101 provides feedback outlining the user story's improvements and additions. In an example embodiment, the spaCy model is used and the extract_components function is used to provide feedback outlining the user story's improvements and additions (i.e., if any elements are missing).

In an example embodiment, when the API development quality score meets or exceeds the threshold score, the user story evaluation system 101 designates the user story as ready for automated API code generation, and promoting the user story to a code generation phase by transmitting the user story details to a code generation system 105 for automated code generation. The generated API code may then be executed on a computing device 102-N. The user story evaluation system 101 verifies that all required components meet minimum quality standards, confirms the presence of necessary technical details, and prepares the user story for automated API code generation. The user story evaluation system 101 validates the extracted components against predefined patterns using named entity recognition results, and checks for consistency in technical specifications based on identified component-specific dependencies. The user story evaluation system 101 ensures alignment with API development standards through analysis of classified technical entities.

At 210, the user story evaluation system 101 iteratively improves the user story based on the generated feedback until the API development quality score meets or exceeds the threshold score. In an example embodiment, the user story evaluation system 101 generates a detailed report of the API development quality score calculation, including component-wise identification of technical entities, providing a component-wise breakdown of scores with associated technical specifications and dependencies, and highlighting areas requiring improvement based on the validated technical entities and identified relationships between components.

As noted above, an example initial user story may read as follows, “As a user, I want to create a new account. I just need to enter my username, email address and password to create an account. I want to be sure that my data is secure and that I can log in quickly and easily at all times. I should be informed in case of any error. The platform should be able to accommodate a lot of users simultaneously without any delays”. Using the user story evaluation system 101, the improved user story is as follows:
As a user, I want to create a new account so that I can access the platform's features.
POST /api/v1/users
Request parameters: username, email, password
Response format: JSON
Authentication: Bearer token required
Error handling: 400 Bad Request, 404 Not Found
Data validation: Username must be a non-empty string, password must be at least 8 characters long
Performance: Handle up to 1000 requests per second with an average response time of less than 200 ms
Security: All data in transit must be encrypted using TLS
Data retrieval: Server=myServerAddress; Database=myDataBase; User
Id=myUsername; Password=myPassword; Table: Users
Pagination: Query parameters: page, pageSize

The above-described illustrative embodiments provide significant advantages relative to conventional approaches. For example, some embodiments are configured to significantly optimize the development of APIs by automating the process of creating and assessing user stories. These and other embodiments can effectively improve the experience of users interacting with data sets in databases. Embodiments disclosed herein use pre-established standards such as completeness, clarity, and relevance that are essential for API development. Embodiments disclosed herein provide a quality threshold that guides developers in improving the user stories to adhere to development standards. Embodiments disclosed herein provide iterative feedback for continuous improvement, maximizing the quality of user stories and development readiness. Embodiments disclosed herein enhance productivity as development teams achieve higher productivity by automating procedures related to code generation and user story evaluation. Embodiments disclosed herein ensure that only excellent user stories move forward to the development phase when a threshold score is set for the effectiveness of the user story, thereby reducing uncertainty and misunderstandings between developers and stakeholders by producing clearer, more complete, and better aligned user stories. Embodiments disclosed herein result in better collaboration and communication between development teams and stakeholders by the reiterative strategy, which offers actionable feedback on user stories that do not meet the threshold, guaranteeing that everyone is working towards the same objectives and fosters a culture of continual improvement. Embodiments disclosed herein ensure that user stories are detailed, understandable, and compliant with API development specifications resulting in improved code quality because code is implemented more consistently and reliably when it is generated automatically using standardized user stories. Embodiments disclosed herein streamline the development process and reducing human labor, allowing companies to launch new APIs more quickly resulting in faster Time-To-Market. Embodiments disclosed herein allow automation of repetitive operations and the provision of actionable feedback for improvement, enabling quick iteration and deployment, allowing organizations to stay ahead of the competition and adapt immediately to market demands. Embodiments disclosed herein generate a user story that is considered ready for development and is eligible for automated code generation processes. Embodiments disclosed herein create precise, structured user stories that are optimized for automated code generation by employing natural language processing (NLP) approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

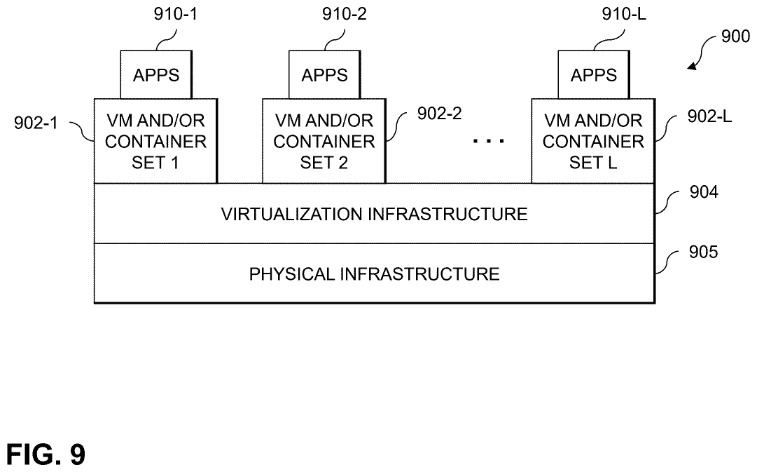

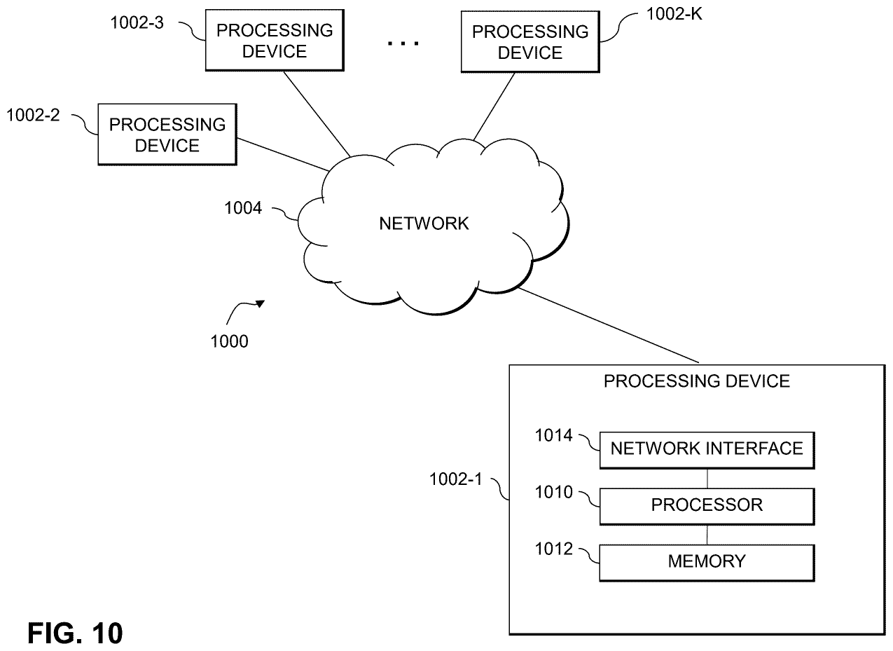

Illustrative embodiments of processing platforms will now be described in greater detail with reference to FIGS. 9 and 10. Although described in the context of the information processing system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, where the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of the information processing system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a microcontroller, an application-specific integrated circuit (ASIC), a field-programmable gate array (FPGA) or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a user story evaluation system, a user story describing requirements for an application programming interface (API) development;
extracting, by the user story evaluation system, using natural language processing techniques, a plurality of components from the user story;
calculating, by the user story evaluation system, an API development quality score by evaluating each extracted component against predefined quality criteria for API development, assigning predefined weights to each evaluated component based on a determined relative importance to API development, wherein the predefined weights correspond to specific API development requirements and generating the API development quality score representing an overall measure of the user story's completeness and technical adequacy for API development;
comparing, by the user story evaluation system, the calculated API development quality score against a predetermined threshold score;
when the API development quality score is below the threshold score:
identifying missing or incomplete components;
generating specific feedback for improving the identified components;
providing suggestions for modifying the user story to meet requirements associated with the predetermined threshold score; and
iteratively improving, by the user story evaluation system, the user story based on the generated feedback until the API development quality score meets or exceeds the threshold score, wherein the method is implemented by at least one processing device comprising a processor coupled to a memory.

2. The method of claim 1 further comprising:
when the API development quality score meets or exceeds the threshold score:
designating the user story as ready for automated API code generation; and
promoting the user story to a code generation phase.

3. The method of claim 2 wherein promoting the user story to code generation comprises:
verifying all required components meet minimum quality standards;
confirming the presence of necessary technical details; and
preparing the user story for automated API code generation.

4. The method of claim 1 wherein the components comprise an endpoint uniform resource locator (URL), a Hypertext Transfer Protocol (HTTP) method, request parameters, a response format, authentication requirements, error handling specifications, data validation rules, a use case description, performance requirements, data retrieval details, security requirements and pagination parameters.

5. The method of claim 4 wherein the endpoint URL component comprises a specific URL for accessing the API and defined path parameters within the URL.

6. The method of claim 4 wherein the request parameters component comprises path parameters defined as variables within the endpoint URL, query parameters added following a question mark in the URL, and body parameters for PUT, PATCH, and POST operations.

7. The method of claim 4 wherein the response format component specifies the format for returned data and a structure for response parsing and handling by clients.

8. The method of claim 4 wherein the authentication requirements component comprises specification of authentication methods, token requirements, and security protocols for API access.

9. The method of claim 4 wherein the error handling component comprises error codes, error messages, and specific handling procedures for different error scenarios.

10. The method of claim 4 wherein the data validation rules component comprises specifications for mandatory fields, data type requirements, and field-specific limitations.

11. The method of claim 4 wherein the data retrieval details component comprises database connection strings, table specifications, view definitions, and data source access parameters.

12. The method of claim 4 wherein the security requirements component comprises encryption requirements, rate limiting specifications, and data protection measures.

13. The method of claim 4 wherein the pagination component comprises page size specifications, offset parameters, and total items tracking.

14. The method of claim 1 wherein extracting, by the user story evaluation system, the components using natural language processing techniques comprises:
performing tokenization to divide the user story text into discrete elements, wherein the discrete elements comprise words, numbers, and special characters;
performing sentence segmentation by identifying sentence boundaries based on punctuation marks and grammatical structures; and
analyzing the grammatical structure using dependency parsing to determine relationships between words and identify component-specific dependencies within the user story.

15. The method of claim 14 wherein the natural language processing techniques further comprise:
performing named entity recognition to identify and classify specific technical entities within the user story, wherein the technical entities comprise at least database names, table names, API endpoints, and data fields;
performing part-of-speech tagging to label words with corresponding parts of speech to facilitate identification of technical specifications and requirements; and
validating identified technical entities against predefined API development patterns and nomenclature standards.

16. The method of claim 1 wherein calculating, by the user story evaluation system, the API development quality score comprises:
evaluating each component extracted through natural language processing against predefined criteria for completeness and clarity, wherein the evaluation incorporates identified technical entities and grammatical relationships;
multiplying each component's base score by an impact multiplier based on validated technical specifications to generate a weighted score; and
summing the weighted scores of all components to generate the API development quality score.

17. The method of claim 1 further comprising:
validating the extracted components against predefined patterns using named entity recognition results;
checking for consistency in technical specifications based on identified component-specific dependencies; and
ensuring alignment with API development standards through analysis of classified technical entities.

18. The method of claim 1 further comprising:
generating a detailed report of the API development quality score calculation, including component-wise identification of technical entities;
providing a component-wise breakdown of scores with associated technical specifications and dependencies; and
highlighting areas requiring improvement based on the validated technical entities and identified relationships between components.

19. A system comprising:
at least one processing device comprising a processor coupled to a memory;
the at least one processing device being configured:
to receive, by a user story evaluation system, a user story describing requirements for an application programming interface (API) development;
to extract, by the user story evaluation system, using natural language processing techniques, a plurality of components from the user story;
to calculate, by the user story evaluation system, an API development quality score by evaluating each extracted component against predefined quality criteria for API development, assigning predefined weights to each evaluated component based on a determined relative importance to API development, wherein the predefined weights correspond to specific API development requirements and generating API development quality score representing an overall measure of the user story's completeness and technical adequacy for API development;
to compare, by the user story evaluation system, the calculated API development quality score against a predetermined threshold score;
when the API development quality score is below the threshold score:
to identify missing or incomplete components;
to generate specific feedback for improving the identified components;
to provide suggestions for modifying the user story to meet requirements associated with the predetermined threshold score; and
to iteratively improve, by the user story evaluation system, the user story based on the generated feedback until the API development quality score meets or exceeds the threshold score.

20. A computer program product comprising a non-transitory processor-readable storage medium having stored therein program code of one or more software programs, wherein the program code when executed by at least one processing device causes said at least one processing device:
to receive, by a user story evaluation system, a user story describing requirements for an application programming interface (API) development;
to extract, by the user story evaluation system, using natural language processing techniques, a plurality of components from the user story;
to calculate, by the user story evaluation system, an API development quality score by evaluating each extracted component against predefined quality criteria for API development, assigning predefined weights to each evaluated component based on a determined relative importance to API development, wherein the predefined weights correspond to specific api development requirements and generating API development quality score representing an overall measure of the user story's completeness and technical adequacy for API development;
to compare, by the user story evaluation system, the calculated API development quality score against a predetermined threshold score;
when the API development quality score is below the threshold score:
to identify missing or incomplete components;
to generate specific feedback for improving the identified components;
to provide suggestions for modifying the user story to meet requirements associated with the predetermined threshold score; and
to iteratively improve, by the user story evaluation system, the user story based on the generated feedback until the API development quality score meets or exceeds the threshold score.
